(19) United States
(12) Patent Application Publication
(10) Pub. No.: US 2018/0037158 A1
(43) Pub. Date: Feb. 8, 2018

(54) MOTION-INDICATING LICENSE PLATE FRAME

(71) Applicant: Auto E-Alert, LLC, Larkspur, CA (US)

(72) Inventor: Paul L. Schaye, New York, NY (US)

(21) Appl. No.: 15/658,241

(22) Filed: Jul. 24, 2017

Related U.S. Application Data
(60) Provisional application No. 62/365,944, filed on Jul. 22, 2016.

(51) Int. Cl. B60Q 1/44; F21V 19/00; B60Q 1/26

(52) U.S. Cl. CPC B60Q 1/442; B60Q 1/2661; B60Q 1/2696; B60Q 1/445; B60Q 1/441; F21V 19/001

(57) ABSTRACT

A visual deceleration indication apparatus signals to pedestrians and other vehicles that a vehicle is slowing down or coming to a stop. Illuminating devices, such as LEDs, contained in a license plate frame located in the front of the car, are activated when the vehicle decelerates. An accelerometer or other sensory device is used to detect deceleration and sends a signal to illuminate the LEDs, thereby letting others know that the vehicle is slowing down. The license plate frame may be connected directly to a rear brake light component without the use of accelerometers or other sensors. When the brake is applied, the LEDs in the license plate frame are illuminated. The LEDs may be contained in other forms and located in different positions on the front or side of the car.

### CROSS-REFERENCE TO RELATED APPLICATION

This application claims priority to provisional application No. 62/365,944, filed Jul. 22, 2016, entitled “Method And System For Providing Alerts Based On Speed Of A Moving Vehicle” which is incorporated herein by reference for all purposes.

### FIELD OF THE INVENTION

The present invention relates generally to vehicle safety components. More specifically, it relates to a visual deceleration apparatus that illuminates in a flashing mode when decelerating and a continuous mode when the vehicle has come to a complete stop as a signal to pedestrians and other vehicles.

### BACKGROUND

Presently, distracted driving has become an increasingly important issue for vehicle and road safety. The clearest example of this arises from drivers using mobile devices while driving preventing them from paying attention to other vehicles and pedestrians. Other sources of distractions include interacting with a car's entertainment system, also becoming increasingly complex. As this trend continues, other vehicles and pedestrians would like to know whether an approaching vehicle is slowing down or coming to a stop and be able to tell that it is doing so from looking only at the front of the car. Rear brake lights have long served this function but from the back of the car and is primarily for the benefit of the vehicle behind it, to let that car know that the car in front is slowing down. The type of visual signal provided by the present invention—that a vehicle is slowing down—is beneficial for cars and people in front of a moving car. For example, it would be useful to a person crossing a road at a crosswalk to be able to tell more clearly that an approaching car is slowing down or braking so the person is assured that it is safe to cross. In another example, a driver sees in her rear-view mirror that a car is approaching from behind her. It would be beneficial to this driver to see a signal that the car behind her is slowing down, a signal that is of course not available from the approaching car's rear brake light. Furthermore, the need for a visual signal is especially acute with the advent of autonomous and semi-autonomous driving technology. Pedestrians and other drivers (and other self-driving vehicles) need assurance that a vehicle is slowing down. As such, what is needed is a front or side-positioned visual and/or indicator to signal that a moving vehicle is braking, decelerating, or coming to a stop.

### SUMMARY

In one aspect of the invention, a deceleration indication apparatus for a vehicle includes a license plate frame and a printed circuit board containing an accelerometer, multiple LEDs, and circuitry. It also has an electrical connection to a power source, wherein deceleration of the vehicle causes the accelerometer to send a signal through the circuitry to illuminate the thereby providing a visual indication that the vehicle is decelerating and possibly coming to a stop.

In another aspect of the invention, a front brake light apparatus for a vehicle includes a license plate frame, a printed circuit board containing multiple LEDs and circuitry. An electrical connection to a rear brake light component of the vehicle provides power to the apparatus. It also provides an actuation signal to the printed circuit board to illuminate the LEDs and to supply power to the apparatus when the rear brake light component is activated.

Another aspect of the invention is a method of illuminating LEDs on a license plate frame of a vehicle. An accelerometer or other sensor on the vehicle detects deceleration of the vehicle. A signal is sent from the accelerometer or other sensor to the circuitry in the frame. This actuates or illuminates the LEDs upon deceleration.

### BRIEF DESCRIPTION OF THE DRAWINGS

The invention and the advantages thereof, may best be understood by reference to the following description taken in conjunction with the accompanying drawings in which:

FIG. 1 is a frontal view of a license plate frame containing a license plate and showing the location of LEDs in accordance with one embodiment;

FIG. 2 is a schematic figure showing in more detail components comprising a license plate frame in accordance with one embodiment;

FIG. 3 is a block diagram showing multiple configurations of the apparatus, power supply, and brake components in accordance with various embodiments; and

FIG. 4 is an illustration of a front view of a car showing possible locations of the visual deceleration apparatus in accordance with various embodiments.

### DETAILED DESCRIPTION

In the described embodiment, an apparatus for implementing a license plate frame that provides a visual indication (light illumination) of a moving vehicle that is braking, decelerating, or coming to a stop is described in the various figures. There are numerous embodiments, some of which utilize a car brake mechanism or system, or only the rear brake light component, or both. In other embodiments, the visual indication system is not coupled to any brake component of the car but rather utilizes accelerometers or other sensory technologies to determine deceleration. In yet other embodiments, the visual indication system is not in the form of a license plate frame, but is rather in the form of a light component or other component in the front or on the side of the car.

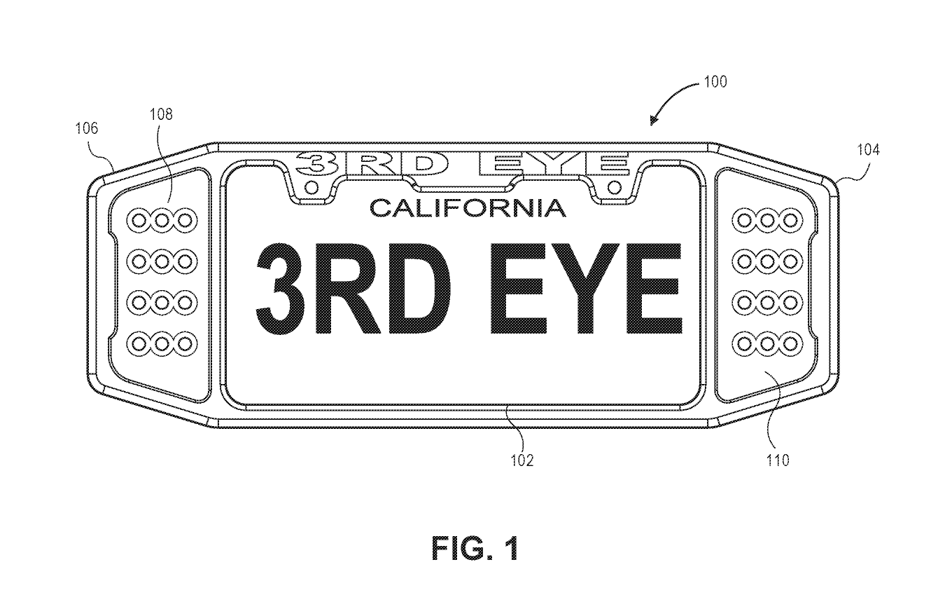

The described embodiment is a license plate frame with LEDs on both sides of the frame, as shown in the figures. The power source for the LEDs and circuitry contained in the frame is supplied by the car, typically the battery. The deceleration input may be provided by, for example, the car's rear brake light sub-components, accelerometers, or other sensors. An illustration of a license plate frame apparatus is shown in FIG. 1.

In the described embodiment, the license plate frame is attached to the front of a vehicle and secures a license plate. Other locations or placement of the LEDs in the front of the vehicle, typically a car, are possible, as described below. In other embodiments, different types of visual indications or illumination sources can be used, such as OLEDs, halogen lights, and the like. On the sides of the license plate frame are layers or configurations of lenses, reflectors, LEDs, and printed circuit boards (PCBs). Embedded in at least one of the PCBs is one or more accelerometers. The accelerometer provides signals to illuminate the LEDs when deceleration is detected. As such, the LEDs are illuminated, specifically, they flash when a car slows down and illuminate continuously when stopped, such illumination being clearly visible to other drivers and to pedestrians. It signals to other drivers and pedestrians that the car is decelerating, braking, or coming to a stop.

Different types of accelerometers can be used. In the described embodiment, a one-way accelerometer is used to measure movement on one axis, forward or backward. Two-way accelerometers (measuring movement on two axes) can also be used to indicate deceleration when braking and when turning (assuming the car slows down when it turns).

As noted above, in one embodiment, the license plate frame is an apparatus for visually signaling or in some manner indicating motion, specifically, slowing down, as measured by accelerometers. In another primary embodiment, the frame is an apparatus for visually signaling braking and acts essentially as a front brake light, without the use of accelerometers.

In some embodiments, the power source for the LEDs and circuitry comes directly from the car battery. In other embodiments, the power source comes directly from a brake component, such as the rear brake light or the main brake system of the car, using conventional means, therefore without requiring direct connection to the battery or other power source. As noted, in one embodiment, the power source for the frame may be sourced from power being supplied to the rear brake light. As such, the frame is powered when power to the rear light is supplied. In this embodiment, an accelerometer is not required; the frame LEDs are illuminated when the rear brake light is actuated, flashing at first and continuous when the car has stopped. In other embodiments, the LEDs may illuminate continuously the entire time or flash the entire time, even when at a complete stop. In the described embodiment, power for the frame is sourced from the car battery. In other embodiments, any 12v power supply that is part of the car is feasible. In these embodiments, the accelerometer instructs or dictates when power from the car battery or other source is used to light up the LEDs.

In one embodiment, the accelerator is on one of the PCBs which is housed on the left or right side of the frame. There are two PCBs, one on each side. One of the PCBs contains the logic, a transformer, an accelerometer, and other micro circuitry.

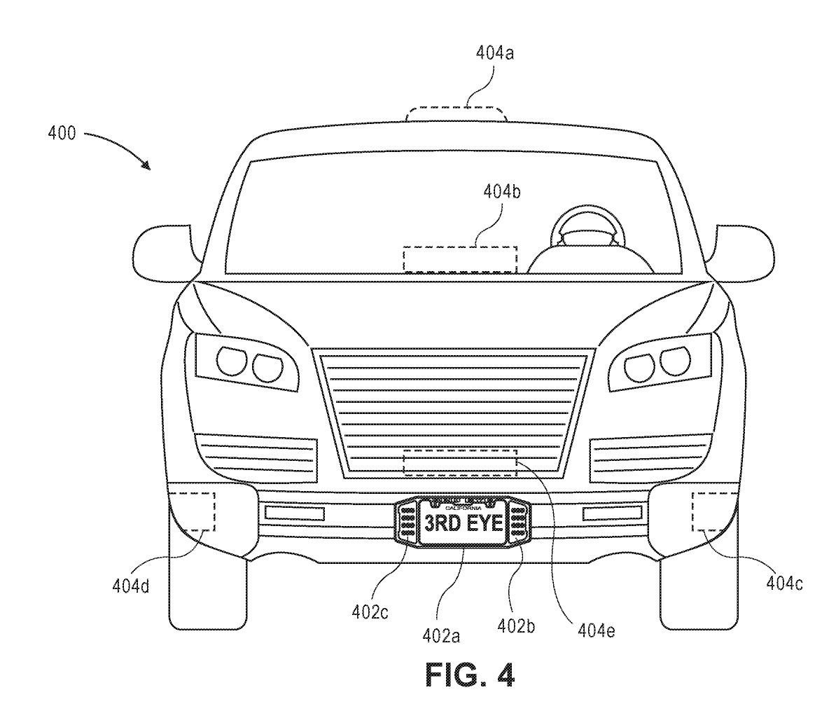

It is helpful to note that the front visual deceleration apparatus is made a component of the car during the manufacturing of the car, similar with the embedded nature of the rear brake light (this is often referred to as “factory installed”). As such, the visual indicator, that is, the LEDs or other light sources, can be installed at any suitable or feasible (from an engineering/manufacturing standpoint) position in the front of the car. This can include being embedded as a light source in the front headlamp compartments, as a light source near or on the rear-view mirror, on the roof, or as a light source in the low, center area of the windshield (similar to where the rear brake light is on the rear window). These embodiments are shown in FIG. 4. The circuitry and wiring of the visual deceleration apparatus, such as the wires going to the battery or to the rear brake light, for example, are installed during manufacture and essentially become part of the car's electrical wiring harness. Other workable locations may include the roof, wheel hubs, and the front of the car, such as on the grill. The illumination device can also be internal or in the interior of the car. In other embodiments, some of the components may be inside and others on the outside of the car.

Again, as described above, the front visual deceleration apparatus of the present invention can be characterized as a front brake light in accordance with specific embodiments. Specifically, when the LEDs or other visual indicators come on when the rear brake lights come on. The apparatus can also be characterized as a vehicle deceleration indicator, rather than a braking system, in that it indicates a change in motion or speed of the vehicle. Here, one type of sensor used to signal deceleration is an accelerometer. The sensitivity of the accelerometer can be fine-tuned so that the lights do not come on every time there is a slight deceleration (e.g., when a slight “tapping” on the brake pedal) or when the car comes to a sudden stop (e.g., when “slamming” the brakes). The accelerometers can be adjusted or tuned so that they only send a signal to the LEDs when certain speed or rate of deceleration is detected, a tuning that implements and enables the safety goals of the invention, described above, without causing false triggers. For example, the LEDs should not illuminate unnecessarily, such as, every time the brake pedal is pressed slightly or pressed for only a short duration (e.g., shorter than 1 second). In many cases, there will be significant overlap of when the LEDs illuminate and the length of time they stay on in all embodiments. In other words, whether using solely braking components, solely accelerometers or other sensors, or a combination of these, the LEDs will illuminate and stay on for similar durations.

In another embodiment, Bluetooth signals may be used to communication signals between the license plate frame and a braking component in the car. The frame circuitry contains a Bluetooth transceiver and is coupled with a Bluetooth transceiver on a brake pedal or other braking component. When there is downward movement of a brake pedal, a signal is sent to the Bluetooth transceiver connected to the LEDs. In other embodiments, the frame operates through Wi-Fi technology. A mobile device can be wirelessly connected to the vehicle Wi-Fi or a close Wi-Fi signal and be activated via the Internet. In yet another embodiment, photo-sensors can be used to detect motion of a vehicle or pedestrian in close proximity of the sensor and can illuminate the LEDs in the license plate frame. In another embodiment, audio or voice commands are used by the driver or other passengers in the car to illuminate the LEDs in the frame. For example, a microphone can detect audio signals (noise or voices) from, for example, a driver when the driver knows when she is going to slow down because of a pedestrian. The apparatus may also include logic to understand voice commands. Other embodiments, the apparatus may include an IR sensor to detect heat or a line of sight IR signal, such as driving into a garage or wall that has an IR sensor to help guide the vehicle and illuminates the LEDs.

FIG. 1 is an illustration of a visual deceleration apparatus in the form of a license plate frame in accordance with one embodiment. A frame 100 has a center section 102 for holding a license plate. Two side sections 104 and 106 display 12 LEDs 108 and 110 in each section. These LEDs illuminate when the vehicle decelerates. Input to the LED circuitry comes from either a brake system component from accelerometers, or from other types of sensors as described above.

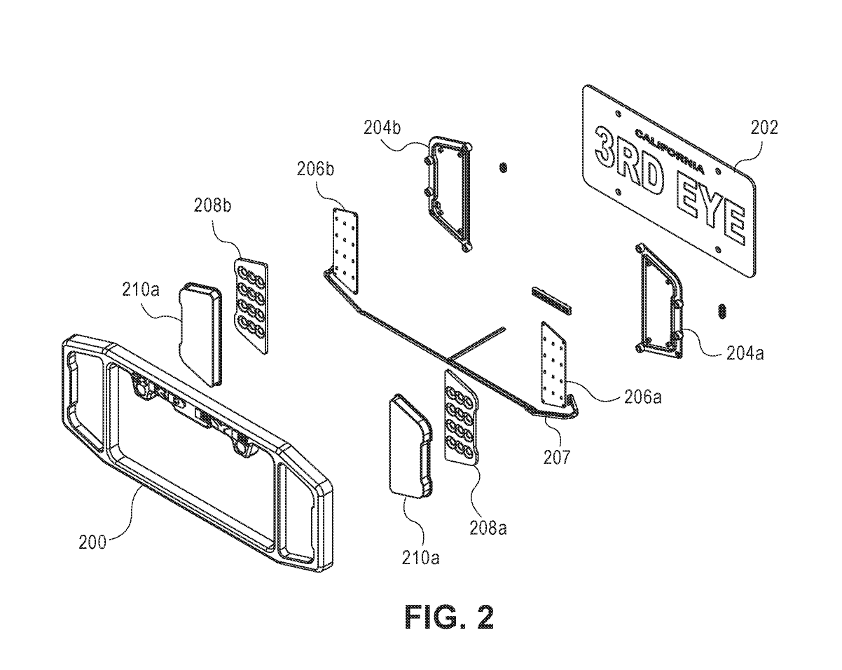

FIG. 2 is a modular drawing showing the various components comprising a visual deceleration apparatus in the form of a license plate frame. A license plate frame 200 secures a license plate 202 in the center section of the frame. Frame 200 has two side sections each containing a rear lens housing 204a and 204b. Two printed circuit boards (PCBs) 206a and 206b, cut to fit in the two side sections, each containing logic, micro-circuitry, and, in one embodiment, 12 LEDs (3×4). In one embodiment, at least one of PCBs 206a and 206b contains at least one accelerometer. Other types of sensors, such as an IR sensor, a Bluetooth transceiver, and others, may be contained on the PCBs or elsewhere in the apparatus. One or more wires 207 are connected to the PCBs and provide power to illuminate the LEDs and power the apparatus. For example, these wires may go directly to the car battery, to a rear brake light sub-system, or to both. More generally, the wires may go to any suitable power source in the vehicle. Layered on top on the PCBs, to protect the circuitry and more specifically to magnify illumination from the LEDs, are two reflectors 208a and 208b, each having 12 openings positioned the same as the LEDs, as shown in the figure. Covering reflectors 208a and 208b are lenses 210a and 210b which also help magnify the LEDs which fit securely in the two side sections of the frame and are coupled with rear lens housings 204a and 204b.

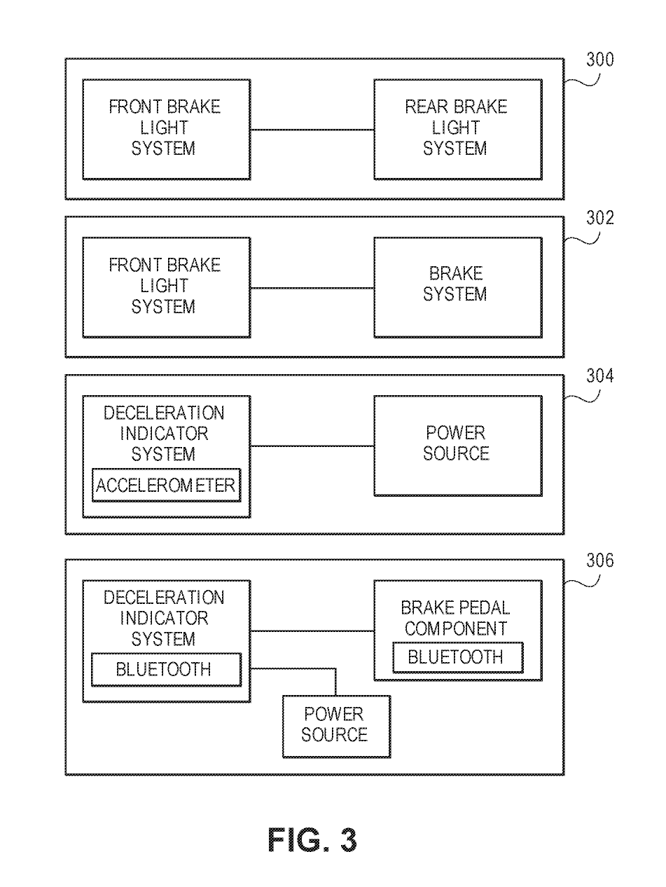

FIG. 3 is a block diagram showing example configurations of visual deceleration apparatus connected to other components of the car in accordance with various embodiments. In 300 the deceleration illumination apparatus is characterized as a front brake light system. It is actuated by and draws power from the car's rear brake light sub-system (a “sub-system” of the car's larger, overall brake system). When the rear brake light comes on, the front brake light LEDs and other indicators, are triggered or actuated. Various positions of the front brake lights are shown in FIG. 4. Configuration 302 is similar to 300 in that the deceleration apparatus is characterized as a front brake light system. It is connected with the car's brake system which powers it and also provides an actuation signal to the LEDs when the car's brake is applied. The same actuation signal may be used to actuate the rear brake light sub-system.

In another embodiment, the front visual deceleration apparatus is not connected or dependent in any way with the car's brake system. In configuration 304, the apparatus is characterized as a deceleration indicator system and draws power directly from the car's battery (or other suitable DC power source in the car). The PCBs contain at least one accelerometer, which may have one-way or two-way capabilities. As described above, the accelerometer signals or actuates the LEDs when the vehicle is slowing down. The sensitivity of the accelerometer is tuned so that a signal is sent when the car is slowing down at a certain rate. It is useful to note that the car can decelerate at that rate without necessarily having to apply the brakes. There are several other embodiments that make use of at least accelerometers, rear brake lights, and brake systems, or combinations thereof. For example, one embodiment may use accelerometers to actuate the LEDs and draw power and receive an actuation signal from a brake component.

In other embodiments, other suitable technologies for communicating an actuation signal may be used. One example is shown in configuration 306. Here the deceleration indicator system has a Bluetooth transceiver that is connected and paired with another Bluetooth transceiver that is connected to a braking component, such as a brake pedal. When the brake pedal is pressed, for example, a signal is sent to the Bluetooth component in the license plate frame. The deceleration indicator system is powered by, for example, the car battery or other source as in configuration 304. As mentioned, configuration 306 is merely one example of using alternative technologies to actuate a front visual deceleration system. The use of other technologies, such as those described above may involve an additional

FIG. 4 is an illustration showing the front of a car and locations of the front light apparatus in accordance with various embodiments. A car 400 is used for illustration. The apparatus of the present invention can be used on numerous other motorized, electric, and non-motorized moving vehicles, includes bicycles [insert other examples if any]. In the described embodiment, the visual deceleration apparatus is in the form of a license plate frame having a center section 402a containing a license plate and two side sections 402b and 402c that contain the LEDs, PCBs, micro-circuitry, and in some embodiments, at least one accelerometer, Bluetooth transceiver, or other type of sensor as described above. Other possible locations of the visual deceleration apparatus are shown: on the roof of the car 404a; in the car at the front center windshield 404b; as a part of or near the front headlamp 404c-d; and on the grate 404e. There are other possible locations for the apparatus inside the car or for some of the components of the apparatus to be interior. For example, a microphone or other sensor that rely on input from the driver or passenger may be inside the car and other components, such as the LEDs outside and at multiple locations. In yet another embodiment, the LEDs may not be fully frontal but on the sides, such as on wheel hubcaps, side view mirrors, or other locations on the side of the car that are clearly visible to pedestrians about to cross in front of the car. In the various embodiments, a method of illuminating the LEDs on the car as described above is described. A method of illuminating LEDs on a license plate frame includes steps of detecting a deceleration of the vehicle using an accelerometer in the frame. This detection causes the transmission of a signal from the accelerometer to circuitry in the frame. This actuates the LEDs in the frame upon deceleration. In another embodiment, the signal to the LEDs and circuitry comes from the rear brake light system as described above. In yet another embodiment, the signal may come from a sensor, such as one of the multiple types described above, to activate the LEDs.

On this point and in conclusion, we return to one of the primary purposes of the present invention: providing a visual indication to pedestrians and other drivers who are in front of the moving vehicle that the vehicle is slowing down. With drivers being distracted with handheld devices and in-car interactive systems, the safety of pedestrians and other drivers improves in specific situations if they are confident that a car is slowing down or coming to a stop. Furthermore, with the advancement of autonomous and semi-autonomous driving technology in vehicles (including trucks and buses), people and other vehicles need visual and/or audio assurance that they are safe and the various embodiments of the present invention implement this important safety component. Finally, it is important to note that pedestrian responses to approaching vehicles and environmental factors are critical factors in avoiding pedestrian-vehicle crashes. The present invention's signal provides pedestrians with greater degrees of certainty about an approaching vehicle's actions and the driver's intent. Despite the thought processes pedestrians already employ in judging when it is safe to cross, pedestrian and vehicle crashes still occur at an alarming rate. The present invention is an additional accretive measure that will aid in meaningfully reducing accidents involving pedestrians, cyclists, and other motor vehicles.

Various embodiments described herein involve distinct features. It should be appreciated that any feature or functionality from one figure or embodiment may be incorporated into any other figure or embodiment.

Although some embodiments of the invention have been described in detail, it should be appreciated that the invention may be implemented in many other forms without departing from the spirit or scope of the invention. It should be appreciated that in some embodiments, one or more components in the apparatus or the steps in the methods may be modified, reordered and/or deleted. Therefore, the present embodiments should be considered illustrative and not restrictive and the invention is not to be limited to the details given herein.

What is claimed is:

1. A deceleration indication apparatus for a vehicle comprising:
a license plate frame;
a printed circuit board containing an accelerometer, a plurality of LEDs, and circuitry; and
an electrical connection to a power source, wherein deceleration of the vehicle causes the accelerometer to send a signal through the circuitry to illuminate the plurality of LEDs thereby providing a visual indication that the vehicle is decelerating.

2. A front brake light apparatus for a vehicle comprising:
a license plate frame;
a printed circuit board containing a plurality of LEDs and circuitry; and
an electrical connection to a rear brake light component of the vehicle, wherein said rear brake light component provides an actuation signal to the board to illuminate the plurality of LEDs and to supply power to the apparatus when said rear brake light component is activated.

3. A method of illuminating LEDs on a license plate frame of a vehicle comprising:
detecting a deceleration of the vehicle using an accelerometer in the frame;
sending a signal from the accelerometer to circuitry in the frame; and
actuating the LEDs upon deceleration.
